(19) United States
(12) Patent Application Publication
(10) Pub. No.: US 2025/0169395 A1
(43) Pub. Date: May 29, 2025

(54) POWER EQUIPMENT UNIT WITH GROUND SPEED RESPONSIVE TO FORCE APPLIED TO A HANDLE GRIP

(71) Applicant: THE TORO COMPANY, Bloomington, MN (US)

(72) Inventors: Chadwick A. Shaffer, Oakdale, MN (US); Patrick J. Shaver, Woodbury, MN (US)

(21) Appl. No.: 18/950,563

(22) Filed: Nov. 18, 2024

Related U.S. Application Data
(60) Provisional application No. 63/603,356, filed on Nov. 28, 2023.

(51) Int. Cl. A01D 34/69; A01D 34/68; A01D 101/00

(52) U.S. Cl. CPC A01D 34/69; A01D 2034/6843; A01D 2101/00

(57) ABSTRACT

A power equipment unit such as a power lawn mower includes a housing, an electric propulsion motor, a handle, a force sensor, and a controller. The electric motor provides the housing with powered movement over a ground surface at a variable ground speed. The handle is movable over a maximum handle travel range spanning between a handle neutral position and a handle maximum position. At least a portion of the force sensor travels a maximum sensor travel range spanning between a sensor neutral position corresponding to the handle neutral position, and a maximum sensor output position corresponding to the handle maximum position. The controller receives input from the force sensor to control the electric propulsion motor.

This application claims priority to and/or the benefit of U.S. Provisional Patent App. No. 63/603,356, filed 28 Nov. 2023, which is incorporated herein by reference in its entirety.

Embodiments of the present disclosure are directed generally to walk-behind powered equipment units (e.g., grounds care vehicles such as power mowers) and, more particularly, to such units having a ground speed responsive to a force applied to a handle grip of the unit.

### BACKGROUND

Power equipment units such as rotary power mowers are used by both homeowners and professionals alike to care for turf and other surfaces. Such units typically include a housing with attached wheels that allow rolling movement over a ground surface. While different power equipment units are known, a rotary lawn mower may include a housing that forms or otherwise supports a cutting deck having a downwardly facing cutting chamber. The cutting chamber may contain a tool, e.g., rotary cutting blade, adapted to cut grass and other vegetation. A power source such as an internal combustion engine may also be carried by the housing. The power source may be operatively coupled to the tool/cutting blade to rotate the cutting blade in a generally horizontal cutting plane. The power source may further be operatively coupled to a traction drive of the power equipment units to rotate or power at least some of the wheels, relieving the operator of having to manually propel the unit over the ground surface during operation.

Walk-behind power equipment units may typically include an upwardly and rearwardly extending handle attached to the housing to allow a walking operator to guide the unit during operation. Various operational controls, e.g., to allow for engagement/disengagement of the tool and/or control of the traction drive, may be provided on the handle. The traction drive may allow variation in ground speed to, for example, better accommodate terrain changes and/or changes in operator walking speed.

### SUMMARY

Embodiments described herein include a power equipment unit having: a housing supporting a tool; an electric motor configured to provide the housing with powered movement over a ground surface at a variable ground speed; and a handle extending rearwardly from the housing. The handle is configured to allow an operator to guide the housing during the powered movement over the ground surface, wherein the handle is movable over a maximum forward handle travel range spanning between: a handle neutral position; and a handle maximum forward position. A force sensor is also provided and is responsive to a force applied to the handle, wherein at least a portion of the force sensor is configured to travel over a maximum forward sensor travel range spanning between: a sensor neutral position, corresponding to the handle neutral position; and a maximum forward sensor output position, corresponding to the handle maximum forward position. The power equipment unit further includes a controller configured to receive input from the force sensor to control the electric motor to increase the ground speed of the housing in a forward direction when increasing force is applied to the handle, wherein the maximum forward sensor travel range is 50% or less of the maximum forward handle travel range.

In another embodiment, a power mower is provided that includes: a housing carrying a cutting blade; ground-engaging members operable to support the housing upon a ground surface; and an electric motor operatively connected to, and adapted to selectively power, one or more of the ground-engaging members to propel the housing over the ground surface at a variable ground speed. The mower further includes a handle having a handle tube extending rearwardly from the housing and a handle grip movably mounted near an upper portion of the handle. The handle grip is configured to allow an operator to grip the handle grip and thereby guide the housing during mower operation. The handle grip is movable, relative to the handle tube, over a maximum forward handle travel range between a handle neutral position and a handle maximum forward position. The mower further includes a force sensor having a stationary portion and a movable portion configured to move or deflect relative to the stationary portion. The force sensor is operatively connected to the handle such that the force sensor produces an electrical sensor signal proportional to a force applied to the handle grip, wherein the movable portion moves over a maximum forward sensor travel range spanning between: a sensor neutral position, corresponding to the handle neutral position; and a maximum forward sensor output position, corresponding to the handle maximum forward position. The mower also includes a controller that receives the sensor signal and generates an electrical drive command signal to the electric motor, thereby varying the ground speed of the housing in proportion to the force applied to the handle grip, wherein the maximum forward sensor travel range is 50% or less of the maximum forward handle travel range.

In still another embodiment, a power equipment unit is provided that includes: a housing supporting a tool; an electric motor configured to provide the housing with powered movement over a ground surface at a variable ground speed; and a handle extending rearwardly from the housing, the handle configured to allow an operator to guide the housing during the powered movement over the ground surface. The handle includes a handle frame and a handle grip coupled to the handle frame, the handle grip movable, relative to the handle frame, over a maximum forward handle travel range spanning between: a handle neutral position; and a handle maximum forward position. The power equipment unit further includes a force sensor responsive to a force applied to the handle grip, wherein at least a portion of the force sensor is configured to travel over a maximum forward sensor travel range spanning between: a sensor neutral position, corresponding to the handle neutral position; and a maximum forward sensor output position, corresponding to the handle maximum forward position. A bellcrank is also provided and includes a first arm connected to the handle grip and a second arm connected to the force sensor. A controller is provided and is configured to receive input from the force sensor to increase speed or torque of the electric motor when increasing force is applied to the handle grip.

In still yet another embodiment, a power equipment unit is provided that includes: a housing supporting a tool; an electric motor configured to provide the housing with powered movement over a ground surface at a variable ground speed; and a handle extending from the housing. The handle is configured to allow an operator to guide the housing during the powered movement over the ground surface. The handle is movable over a maximum handle travel range spanning between: a handle neutral position; and a handle maximum position. A force sensor responsive to a force applied to the handle is also included, wherein at least a portion of the force sensor is configured to travel over a maximum sensor travel range spanning between: a sensor neutral position, corresponding to the handle neutral position; and a maximum sensor output position, corresponding to the handle maximum position. The unit further includes a controller configured to receive input from the force sensor to control the electric motor to increase the ground speed of the housing when increasing force is applied to the handle. The maximum sensor travel range is 50% or less of the maximum handle travel range.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a front perspective view of a walk-behind power equipment unit (e.g., power mower) according to embodiments of the present disclosure;

FIG. 2 is a diagrammatic view of a power mower in accordance with embodiments of the present disclosure;

FIG. 3 is an isolated perspective view of a handle of the mower of FIG. 1;

FIG. 4 is an enlarged perspective view of an upper portion of the handle of FIG. 3;

FIG. 5 is a section view of the upper portion of the handle taken along line 5-5 of FIG. 3 with various structure removed;

FIG. 6 is an enlarged perspective view of the upper portion of the handle of FIG. 3 with various structure removed;

FIG. 7 is an exploded view of a force sensor and actuation link in accordance with embodiments of the present disclosure;

FIG. 8 is an enlarged partial perspective view of an exemplary sensor housing for use with the mower of FIG. 3 illustrating an exemplary force sensor;

FIG. 9 is an isolated perspective view of a handle for use with a power equipment unit (e.g., power mower) in accordance with other embodiments of this disclosure;

FIG. 10 is an enlarged perspective view of an upper portion of the handle of FIG. 9;

FIG. 11 is another enlarged perspective view of the upper portion of the handle of FIG. 9 with various structure removed;

FIG. 12 is a section view of the upper portion of the handle of FIG. 9 taken along line 12-12 of FIG. 9;

FIG. 13 is a bottom perspective view of the upper portion of the handle of FIG. 9; and

FIG. 14 is a section view similar to FIG. 12 illustrating exemplary operation of the handle.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing that form a part hereof. It is to be understood that other embodiments, which may not be described and/or illustrated herein, are certainly contemplated.

All headings provided herein are for the convenience of the reader and do not limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est and means “that is.” “E.g.” is used as an abbreviation for the Latin phrase exempli gratia and means “for example.”

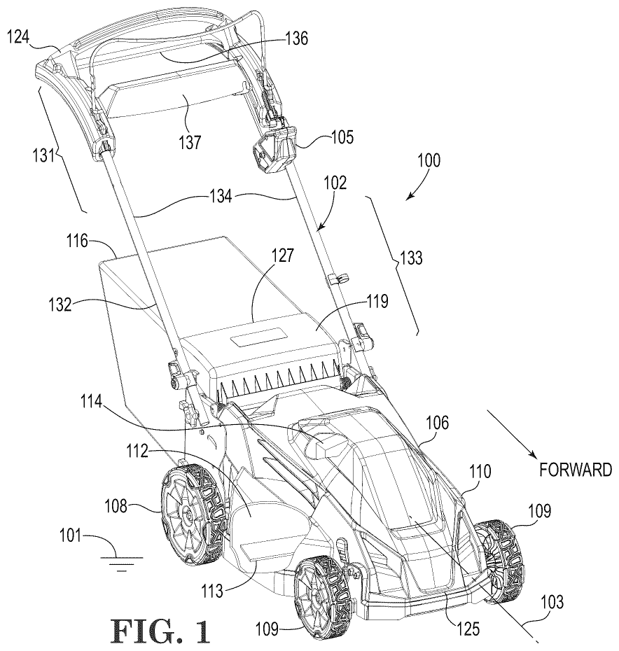

With reference to the figures of the drawing, wherein like reference numerals designate like parts and assemblies throughout the several views, FIG. 1 illustrates a walk-behind power equipment unit such as a rotary power mower 100 in accordance with embodiments of the present disclosure. The mower may include a frame or housing 106 supported upon a ground surface 101 by one or more ground-engaging members (see, e.g., wheels 108, 109). The housing may define a cutting deck 110 that carries a rotary cutting blade 113 therein (see lower cut-away portion in FIG. 1). The mower may further include: a handle 102 extending (e.g., rearwardly) from the housing that is configured to allow an operator to guide the mower during powered movement over the ground surface; and a force sensor responsive to force applied to the handle, e.g., by the operator. Further, the handle is movable over a maximum (e.g., forward and/or reverse) handle travel range, while a movable portion of the force sensor is configured to travel over a maximum (forward and/or reverse) sensor travel range. A handle neutral position may correspond to a sensor neutral position of the sensor, while a handle maximum position may correspond to a maximum sensor output position of the sensor, such that, for example, when an operator pushes the handle to the handle maximum forward position, the movable portion of the force sensor travels to the maximum forward sensor output position. A control system as further described herein may receive input (e.g., electrical signals) from the force sensor to control a traction drive system (e.g., control at least one electric motor) to increase the ground speed of the mower housing in a forward (or reverse) direction when increasing forward (or reverse) force is applied to the handle. In some embodiments, the maximum sensor travel range may be 50% or less, 25% or less, 10% or less, or 5% or less of the maximum handle travel range.

While described and illustrated in the context of a walk-behind power mower 100, such a construction is not limiting as aspects of the depicted/described embodiments may find application to other types of power equipment such as snowthrowers, cultivators, trenchers, debris blowers, dethatchers, aerators, haulers, demolition/construction equipment, and most any other indoor or outdoor ground-working power equipment unit supporting a tool and operated by a walking (or riding) operator. The terms, “mower,” “power mower,” ‘lawn mower,” “walk-behind mower,” and the like may be used interchangeably herein without limitation.

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the mower 100 while the mower is in an operating configuration, e.g., while the mower is positioned such that wheels 108, 109 rest upon a generally horizontal surface (e.g., ground surface 103) as shown in FIG. 1. These terms are used only to simplify the description, however, and not to limit the interpretation of any described embodiment. In a similar manner, terms such as “first” and “second” may be used herein to describe various elements. However, such terms are provided merely to simplify identification of the element(s). Accordingly, if an element is described as “first,” there may or may not be any other subsequent elements—that is, a “second” element is not necessarily present. It is further understood that the description of any particular element as being attached, connected, or coupled to another element may indicate that the elements are either directly attached, connected, or coupled to one another, or are indirectly attached, coupled, or connected to one another via intervening elements.

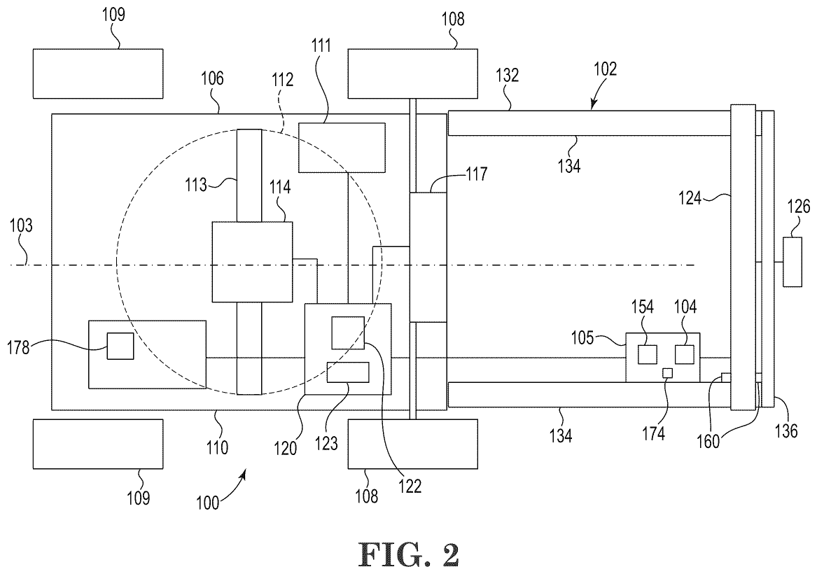

FIG. 1 illustrates a walk-behind power mower 100 in accordance with embodiments of the present disclosure, while FIG. 2 illustrates a diagrammatic view of the same. As shown in these views, the mower may include a handle 102 and a force sensor 104 (which may, in some embodiments, be contained within a sensor housing 105 mounted to a handle tube 134 of the handle as described in more detail below) responsive to a force applied to a handle grip 124 of the handle 102 (e.g., by an operator walking behind the mower and grasping the handle grip). The mower 100 (e.g., a frame or housing 106 of the mower) may define a front end 125 and a rear end 127 with a longitudinal or travel axis 103 extending between the front and rear ends (the longitudinal axis 103 being the axis of mower travel when the mower is traveling in a straight line). As used herein, “transverse” may refer to any laterally extending axis (or plane) that is perpendicular to a vertical plane containing the longitudinal axis 103.

As stated above, the mower housing 106 may be supported for movement over the ground surface 101 by a plurality of wheels 108, 109 and may furthermore carry or otherwise form a cutting deck 110 having a downwardly facing cutting chamber 112. A prime mover (e.g., an internal combustion engine, an electric motor 114 shown in cut-away in FIG. 1 powered by an onboard battery pack 111 (see FIG. 2) or the like) may be carried by or otherwise supported by the housing 106. The prime mover may, directly (e.g., via a drive shaft) or indirectly (e.g., via one or more belts or transmissions) power a tool (e.g., cutting blade 113) such that the blade may rotate within the cutting chamber 112 as is known in the art. Typically, the cutting deck (or at least the blade 113) has an operator-selectable height-of-cut system to allow blade height adjustment relative to the ground surface 101.

Left and right ground-engaging drive members (e.g., rear drive wheels 108; only right drive wheel visible in FIG. 1) operable to support the housing upon the ground surface 101 may be coupled to left and right sides, respectively, of the housing 106. Each drive wheel may be powered to rotate, relative to the housing 106, about a rotational axis such that rotation of the two drive wheels causes the mower 100 to move parallel to (i.e., along) the longitudinal axis 103. In some embodiments, the drive wheels 108 are operatively coupled to the electric motor 114 (e.g., via a belt-driven transmission) such that the “blade” motor 114 also provides power to the drive wheels. However, as shown in FIG. 2, other embodiments may utilize a separate propulsion motor (or motors) 117 to power the drive wheels 108, thus providing the housing with powered movement over the ground surface at a variable ground speed. When a single propulsion motor 117 is utilized, the propulsion motor may include a differential to permit the wheels 108 to rotate differentially so that the operator may easily turn the mower while driving the rear drive wheels. In other embodiments, each wheel 108 may be driven by its own dedicated propulsion motor 117. Accordingly, while the blade 113 is operatively powered by a first electric motor (e.g., the blade motor 114), a second electric motor (e.g., the propulsion motor 117; see FIG. 2) may be operatively connected to, and adapted to selectively power, the drive wheels 108.

The mower 100 may include additional wheels 109 to support, for example, a front portion of the mower in rolling engagement with the ground surface 101. While described herein as utilizing two rear drive wheels and two front wheels, such a configuration is merely exemplary. For example, other embodiments may use more or less wheels (e.g., a tri-wheel configuration), while still other embodiments may provide different drive wheel configurations (e.g., front-wheel drive or all-wheel drive) or different steering configurations (e.g., a vehicle with conventional Ackermann-type steering). Still further, one or more of the wheels may caster to assist with steering the mower during operation. While illustrated herein as wheels, other embodiments may utilize other ground-engaging members (e.g., rollers, tracks, or the like) without departing from the scope of this disclosure.

As shown in FIG. 2, the mower may include a powered implement or tool for performing a ground grooming or ground working operation. In the illustrated embodiments, the tool is configured as a vegetation/grass rotary cutting blade 113 carried by the housing 106 and operatively coupled to a drive shaft of the blade motor 114. As shown in FIG. 1, grass clippings generated by mowing with the cutting blade may be ejected into and captured by a collection bag 116 (e.g., when the mower is in a bagging mode) or, where the bag is removed and a discharge door 119 is closed, the clippings may be distributed over the ground surface 101 (e.g., when the mower is configured in a mulching mode). Although not illustrated, the mower may optionally include an attachment to also permit side discharge of lawn clippings (e.g., when the mower is configured in a side discharge mode).

Electrical systems of the mower, including the blade motor 114 and the propulsion motor 117, may receive power from the onboard battery pack 111 (see FIG. 2), which may be detachable for re-charging and/or designed to be charged while installed on the mower.

The mower may thus be described as including a blade or implement drive system (which includes the blade 113, blade motor 114, and associated controls), and a traction drive system (which includes the drive wheels 108, the propulsion motor 117 and associated controls). While the traction drive system is described herein as providing propulsion of the mower 100 over the ground surface in a forward direction at a variable ground speed, it may, in other embodiments, be configured to provide propulsion at variable ground speeds in a reverse direction (e.g., such as with a trencher), or in both forward and reverse directions. As used herein, variable ground speed indicates that the ground speed may be infinitely variable or variable in small, discrete steps.

As further shown in FIGS. 1 and 2, the exemplary mower 100 may include the handle 102 extending rearwardly (and upwardly) from the housing 106. The handle 102 is configured to allow an operator to guide the housing during powered movement over the ground surface 101 from an operator position behind the mower/handle. While the exact configuration may vary, the handle 102 may include a handle frame 132 attached to the rear of the housing 106. The handle 102/handle frame 132 may further include a lower portion 133 attached to the housing 106, and an upper portion 131 to which various operating controls are attached. In some embodiments, the handle frame 132 may be formed by two, e.g., laterally-spaced, handle tubes 134 connected to one another near their distal or upper ends by a cross member 136 such that the handle frame 132 forms a generally U-shaped member.

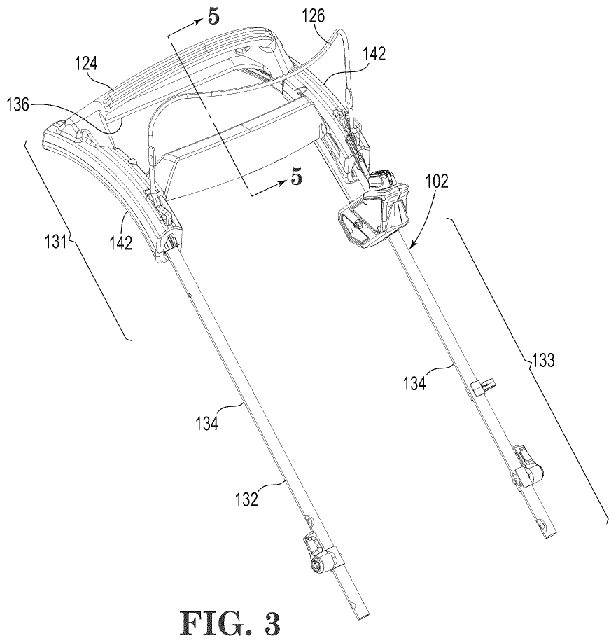

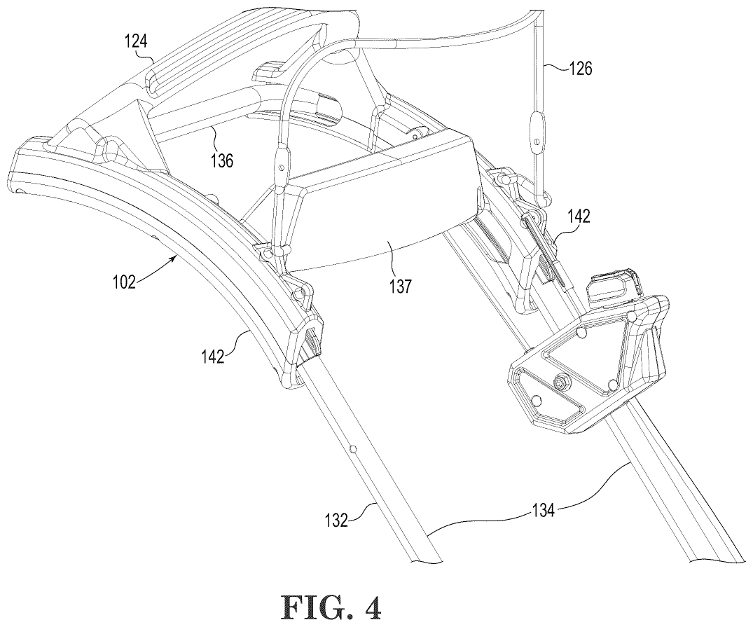

FIGS. 3 and 4 illustrate portions of the handle 102 in isolation. As shown in these views, the upper portion 131 of the handle 102 may form or otherwise carry the transversely extending handle grip 124 movably mounted to the handle frame 132/tubes 134. The handle grip 124 may be sized to allow the operator to grip the handle grip (e.g., with both hands) and thereby guide the mower housing during operation. The handle grip 124 may include a pair of legs 142 to permit movably mounting the handle grip to the handle frame 132 (e.g., to the tubes 134) such that the handle grip 124 moves, e.g., translates, relative to the handle frame. That is to say, the legs 142 may be configured to allow for sliding motion of the handle grip 124 along the handle tubes 134.

The mower (e.g., handle 102) may include various operating controls with which the operator may interact, including controls for actuating and/or controlling both the traction drive system (e.g., propulsion motor 117) and the blade drive system (e.g., blade motor 114). For instance, the control(s) may include a traction control that controls a propulsion speed of the mower 100 (e.g., via the traction drive system). In the embodiments illustrated in FIGS. 1-8, the traction control may include the handle grip 124 and the associated force sensor 104 further described below.

The control(s) carried by the handle 102 may further include an implement control that, in one embodiment, selectively engages/disengages the blade 113 (e.g., actuates/de-actuates the blade motor 114). As shown in FIG. 3, the implement control may include a transversely extending, pivoting bail 126 having a shape that generally mimics that of handle grip 124. While the bail 126 is illustrated forward of handle grip 124, other positions of the bail 126 relative to handle grip 124 are also possible. The term “implement control” is understood to include not only the bail 126, but most any control that may be used to actuate/de-actuate the implement (e.g., blade 113).

To initiate blade 113 (motor 114) rotation, the bail 126 may be pivoted from the open position shown in FIG. 3 to a closed position (not shown, but generally pivoted toward the handle grip 124 until it abuts the same). When the bail 126 is in the closed position, a circuit providing power to the electric blade motor 114 is closed allowing the motor to rotate the cutting blade 113 (assuming related interlocks are in the correct state). Blade engagement may continue for so long as the operator holds the bail 126 in the closed position. The bail 126 is biased such that it may automatically return to its open position relative to handle grip 124 (as shown in FIG. 3) to disengage the blade/blade motor when the operator releases the bail. In some embodiments, a secondary action, e.g., actuating a bail latch, may be needed in order for the operator to move the bail 126 to the closed position, e.g., to mitigate inadvertently starting the blade motor 114.

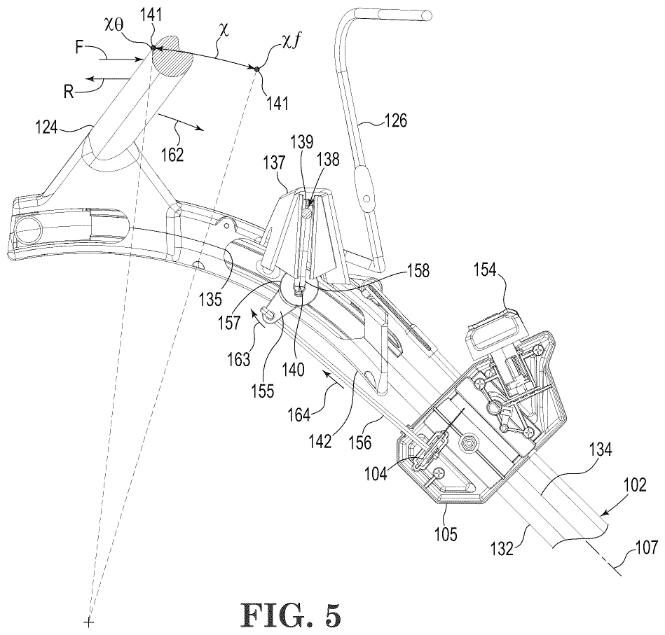

As stated above, the handle grip 124 may be configured to move relative to (e.g., translate along) the handle frame 132 when a forward force F (see FIG. 5) is applied by the operator to the handle grip 124, e.g., resulting from the operator gripping the handle grip and walking in the forward direction. As also stated above, the handle grip 124 may optionally move in the reverse direction relative to handle frame 132 when a rearward force R is applied by the operator to handle grip, e.g., resulting from the operator gripping the handle grip and walking in the rearward direction. The handle 102 may include a biasing member 160 (see FIG. 2) that biases the handle grip 124 to a handle neutral position (e.g., between forward and reverse) corresponding to zero output of the traction drive system/zero velocity of the mower.

As shown in FIG. 5, some embodiments of the handle/handle frame 132 (e.g., each handle tube of the upper portion 131) may include a curved segment such that the handle grip 124 moves along a curved path over at least a portion of the maximum forward handle travel range. This motion may apply a generally axial force to the force sensor 104 as further described below (e.g., the force sensor may be positioned to detect force in a direction parallel to a longitudinal centerline 107 of the handle). For more information regarding curved handle structure, see U.S. Pat. No. 11,464,165 B2.

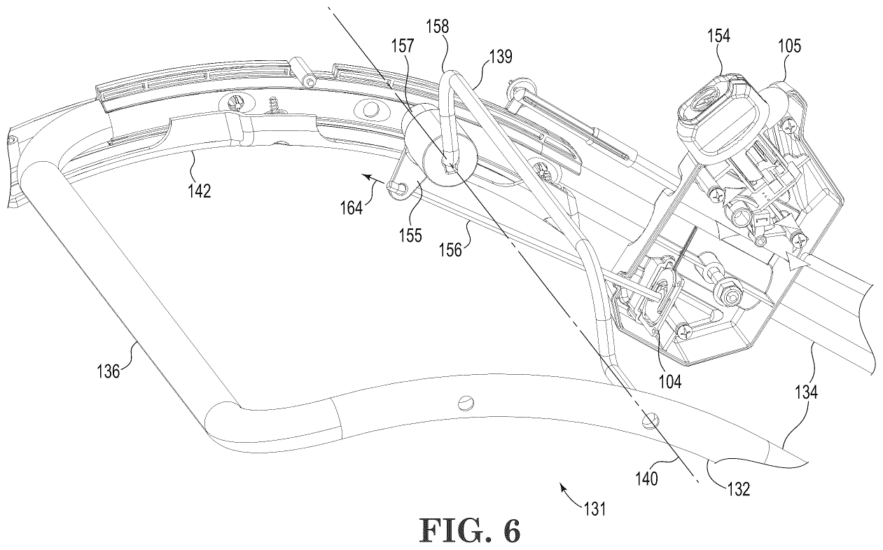

FIGS. 5 and 6 illustrate an exemplary handle grip construction in accordance with embodiments of the present disclosure, with FIG. 5 showing a cross section taken along line 5-5 of FIG. 3, and FIG. 6 showing a perspective view of the upper portion 131 of the handle 102 with some structure removed to better illustrate features of the traction drive system/traction control. As shown in these figures, in addition to the legs 142, the handle grip 124 may also include a cross member 137 (removed in FIG. 6, see also FIG. 4) that is fixed to, and spans between, the legs 142. The cross member 137 defines a channel 138 configured to capture an arm (“captured portion”) 139 of a pivot rod 158. The pivot rod 158 (see FIG. 6) is journalled (pivotally connected) to the handle frame 132 (to each of the handle tubes 134) such that it may rotate about an axis 140. As a result, the captured portion or arm 139 of the pivot rod 158 is engaged with the handle grip 124 such that movement of the handle grip relative to the handle frame/tubes 134 produces pivotal movement of the pivot rod. One end of the pivot rod includes a pivot lever 157 fixed to the pivot rod such that the two components rotate/pivot in unison. As one can appreciate, the pivot rod 158 and pivot lever 157 thus form a bellcrank having a first arm (captured portion 139) connected to the handle grip 124 and a second arm (lever arm 155) connected to the force sensor 104 (via an actuation link 156 as described elsewhere herein). The lengths of these two “arms” of the bellcrank may be varied to alter the mechanical advantage of the bellcrank as also described below.

As shown in FIG. 5, the handle grip 124 of the handle is movable along the curved path relative to the handle frame 132 over a maximum forward handle travel range x spanning between: a handle neutral position (identified by a reference point 141 on the gripping portion of the handle grip 124 being at point x0 corresponding to a sensor neutral position of the force sensor); and the handle maximum forward position (identified by the reference point 141 being at the point xf). Stated another way, the handle maximum forward position is realized when the handle grip 124 translates over the distance x from its neutral position as shown in FIG. 5. A surface 135 of one leg 142 of the handle grip 124 may be configured to abut a stop associated with the handle frame 132 (e.g., abut a surface of the pivot lever 157) to limit the physical travel of the handle grip in the forward direction (similar stops could be provided for reverse handle grip motion as well). The biasing member 160 (see FIG. 2), which may be configured as a torsion spring associated with the pivot rod 158, may return the handle grip 124 to the handle neutral position (wherein the reference point 141 returns to the position x0) when the forward force F (as applied by the operator's hands) is removed from the handle grip

While not wishing to be bound to any specific travel range, the maximum forward handle travel range x (e.g., linear travel of point 141 along the arc of motion shown in FIG. 5) of the handle grip 124 relative to the handle frame 132 (that corresponds to the desired maximum deflection/movement of the force sensor 104) may be 25 millimeters (mm) or less (e.g., about 1 inch or less), e.g., 12 mm (0.5 inches) or less, from the handle neutral position. While not depicted in the figures, the handle grip may also move rearwardly from the handle neutral position when the rearward force R (opposite to the force F) is applied to the handle grip. In some embodiments, the handle grip may move over a maximum rearward handle travel range that is the same as the maximum forward handle travel range. However, in other embodiments, the maximum forward handle travel range may be greater to, for example, permit greater handle travel resolution for forward mower motion.

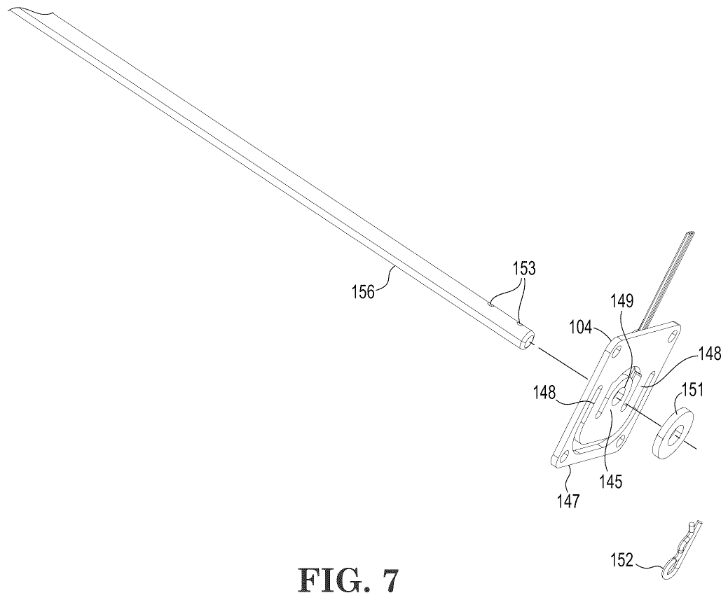

FIG. 6 illustrates the exemplary force sensor 104 located within the sensor housing 105 (cover removed), which is in turn attached to the handle frame 132 (e.g., to one of the handle tubes 134), while FIG. 7 is an isolated, exploded view of the force sensor 104 and the associated actuation link 156. While the configuration of the force sensor may vary, it is in one embodiment a strain-gaged load cell such as a model GLM670 load cell distributed by Xi'an Gavin Electronic Technology Co., Ltd. (Galoce) of Xi'an, Shaanxi, China. This exemplary force sensor may include a perimeter or base (“stationary” portion) 147 fixed to the sensor housing 105, and a hub (“movable” portion) 145 connected to the base by one or more strain-gaged flexures 148. The hub 145 may be configured to move or deflect relative to the stationary portion via the flexure. When the hub 145 is deflected or displaced relative to the base 147, strain gages attached to the flexure detect a magnitude of strain in the flexure due to the movement and output a voltage signal proportional thereto. Stated more broadly, the force sensor 104 is operatively connected to the handle such that it produces an electrical sensor signal proportional to the force F (see FIG. 5) applied to the handle (e.g., to the handle grip). The terms “movement,” “deflection,” “displacement,” and the like of the force sensor are understood herein to refer to the movement of the hub relative to the base due to bending of the flexure.

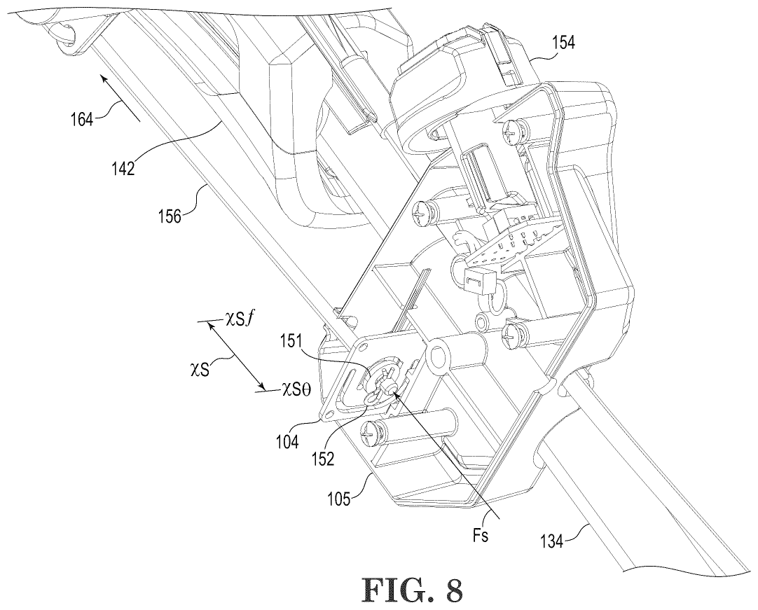

As shown in FIG. 7, the force sensor may further include an aperture 149 formed in the hub 145. The aperture is sized to receive the link 156 with clearance. During assembly, the link may be passed through the aperture and through a washer 151. Once sufficiently inserted, a pin, e.g., cotter pin 152, may be inserted into one of a plurality of holes 153 formed in the link 156 as shown in FIG. 8.

While not necessary to an understanding of this disclosure, the sensor housing 105 may also include a key 154 (see FIG. 5). The key may function as an ignition or interlock switch to be actuated before various aspects of mower operation may occur. For example, the key 154 may need to be actuated before power can be supplied to either or both of the electric motors 114, 117. While shown as a removable, multi-position key, other embodiments may alternatively use other types of switches (e.g., a rocker switch or the like).

As stated above, the force sensor 104 may be operatively configured to detect a magnitude of the force F (applied to the handle grip 124 in the forward direction; see FIG. 5) and vary a forward speed of the propulsion motor 117 (see FIG. 2) in proportion to the force F. Again, while described herein as detecting the force F in the forward direction, the force sensor 104 could be (in addition or alternatively) configured to sense a force R in the rearward direction and vary a rearward speed of the propulsion motor in proportion to the force R. The forward and reverse speed control algorithms that vary the speed of the propulsion motor 117 in response to changes in the force F (and/or R) may be linear or non-linear relative to the motion of the handle grip 124. While described herein as using the force sensor 104 to control a speed output of the motor 117/wheels 108 (e.g., open loop or closed loop control), other embodiments may be adapted to, instead or in addition, use signals from the force sensor to control the torque output of the propulsion motor (e.g., again via open or closed loop control) as described below.

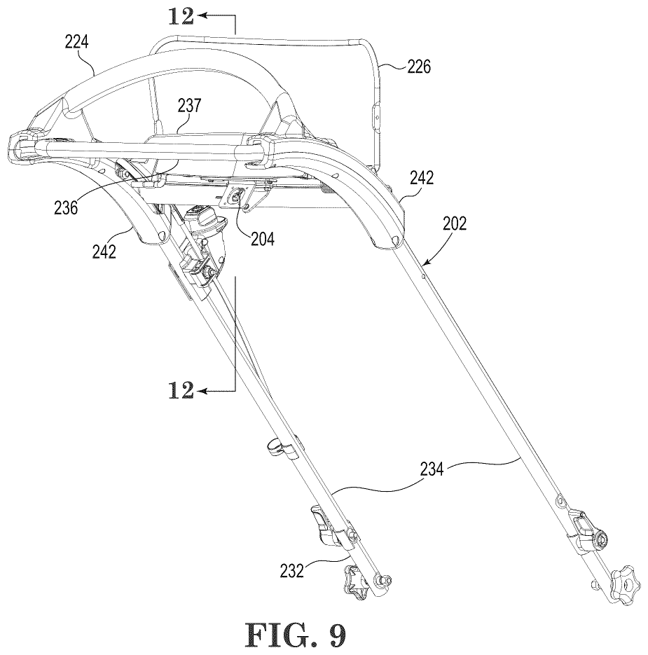

While other embodiments are contemplated, the force sensor 104 may be operatively mounted to the handle 102 so that it acts between the handle frame 132 and the handle grip 124. As shown in FIGS. 1-8, such mounting may be achieved by securing the sensor housing 105 containing the force sensor 104 to one of the handle tubes 134 such that the force sensor is proximate thereto and positioned between the two handle tubes. Such a configuration is not limiting, however, as other embodiments may operatively mount the force sensor to the handle 102 such that the sensor is general located along a longitudinal centerline of the handle (e.g., located generally equidistant between the two handle tubes). The latter is illustrated in FIGS. 9-14.

During operation, the operator may apply the forward force F to the gripping portion of the handle grip 124 as shown in FIG. 5. As the force is applied, the handle grip may move, relative to the handle frame/handle tubes, over the maximum forward handle travel range x (e.g., to anywhere between the handle neutral position and the handle maximum forward position depending on the force F applied). As the handle slides in the direction 162 along the tubes 134, the arm 139 of the pivot rod 158—which is constrained to remain within the channel 138 of the cross member 137—rotates about the axis 140, causing the pivot lever 157 to rotate in the direction 163. As the link 156 has a first end pivotally connected to the handle grip, e.g., to the pivot lever 157 of the pivot rod, the link moves in the direction 164.

The second end of the link 156 is connected to the hub of the force sensor 104 via the washer 151 and cotter pin 152 as already described herein with reference to FIG. 7. Accordingly, the link 156 may be operatively connected to both the force sensor 104 and the handle grip 124 such that the link may convert movement of the handle grip into deflection of the force sensor 104. The configuration of the bellcrank and the pivoting connections of the link 156 to the pivot rod 158/pivot lever 157 and to the force sensor 104 allow for linear travel distance of the handle grip 124 along its curved path to produce a smaller movement/deflection of the force sensor. This relationship between a magnitude of handle grip movement (i.e., over the maximum forward handle travel range x) and the magnitude of force sensor deflection may be varied by, for example, changing a length of a lever arm 155 of the pivot lever 157 (see FIG. 6), and/or changing the initial angular position (“clocking”) of the lever arm 155 (relative to the axis 140) when the handle grip is in the neutral position. Other factors affecting the geometric relationship include the length of the link 156, i.e., the distance between the force sensor and the pivot lever 157 of the handle grip 124.

The pivotal connections of the link 156 may also accommodate lateral and vertical deflections of the handle grip without transferring such movements to the force sensor. Instead, even when such loads are present, this configuration keeps force sensor loading generally along a force sensor centerline, e.g., coaxial with the aperture 149 (see FIG. 7).

As the link 156 is pulled in the direction 164 during application of the force F to the handle 102 (e.g., to handle grip 124), the washer 151 pulls against the hub 145 (see FIG. 7) of the force sensor 104 as shown in FIG. 8. The force of the washer 151 causes a portion (the movable portion or hub 145) of the force sensor to travel somewhere within the maximum forward sensor travel range, xs, spanning between: a sensor neutral position, xs0 (corresponding to the handle neutral position x0; see FIG. 5); and a maximum forward sensor output position xsf (corresponding to the handle maximum forward speed position xf). It is noted that the sensor travel range xs is exaggerated in FIG. 8 for illustration purposes only. The actual deflection/movement of the force sensor/hub between xs0 and xsf is quite small. For instance, the maximum forward sensor travel range xs may be 50% or less of the maximum forward handle travel range, 25% or less of the maximum forward handle travel range, 15% or less of the maximum forward handle travel range, or 10% or less of the maximum forward handle travel range. While not wishing to be bound to any specific embodiment, maximum forward sensor travel range (e.g., the movement/deflection of the force sensor 104 (e.g., of the hub relative to the base), that occurs when the handle grip is moved from its neutral position x0 to its handle maximum forward position xf is three mm (0.12 inches) or less, e.g., one mm (e.g., 0.04 inches) or less.

In some embodiments, the bellcrank geometry of the pivot rod 158/pivot lever 157 yields a mechanical advantage of 1.5:1 or greater, e.g., 2:1, between a resulting output force Fs applied to the force sensor and the input force F applied to the handle grip (e.g., Fs:F). For example, for a relatively light mower with a light spring force of the biasing member 160, the force F required to move the handle grip over the maximum forward handle travel range x (between the handle neutral position and the handle maximum forward position) may be 13 Newtons (N) (3 pounds-force (lbf)). Application of such a force F may generate a force Fs applied to the force sensor (via the link 156) of 27 N (6 lbf). Of course, this bellcrank geometry may be varied to produce different ratios of force F to force Fs without departing from the scope of this disclosure.

In some embodiments a stop (e.g., washer and cotter pin) may be secured to the link 156 on a side of the hub 145 of the force sensor 104 opposite the washer 151/cotter pin 152 shown in FIGS. 7 and 8 to allow the link to apply forces to the force sensor when the handle grip is moved in a reverse direction relative to the handle (e.g., to provide propulsion in reverse). Reverse operation may function in a manner similar to that already described herein with respect to forward operation.

As shown in FIG. 2, the mower 100 may include a controller 120 adapted to monitor and control various mower functions. In some embodiments, the controller 120 may include a processor 122 that receives various inputs and executes one or more computer programs or applications stored in memory 123. The memory 123 may include computer-readable instructions or applications that, when executed, e.g., by the processor 122, cause the controller 120 to perform various calculations and/or issue commands. That is to say, the processor 122 and memory 123 may together define a computing apparatus operable to process input data and generate the desired output to one or more components/devices. For example, the controller (e.g., processor 122) may receive various input data including sensor signals from the force sensor 104 and generate electrical drive (e.g., speed or torque) command signals to the propulsion motor 117, thereby varying the ground speed of the housing in proportion to the force F applied to the handle grip. While described with some specificity herein, the term “controller” may be used to describe components that receive inputs and provide corresponding outputs or commands to other mower systems/components.

In addition to the force sensor, the controller 120 may receive interlock information from the key 154 and may further communicate with other mower systems including the battery pack 111 and motors 114, 117. In some embodiments, a slope sensor 178 may be carried on housing 106 and shown in FIG. 2. The slope sensor 178 may be connected to the controller 120 to provide data on slope or angle of the housing 106, e.g., about a horizontal axis defined by the ground surface 101. In some embodiments, the controller 120 may receive input from the slope sensor and, when the slope exceeds a predetermined threshold, automatically increase (or decrease) velocity or torque output of the propulsion motor 117 as the mower traverses (climbs or descends) a hill. The magnitude of the compensation provided by the controller is designed to allow the operator to maintain the same walking pace without having to push harder on the handle grip 124. For example, as the mower 100 is driven forwardly up a hill, the controller 120 may increase the torque of the motor 117 from the value that would otherwise correspond to force sensor deflection to compensate for the addition load.

In some embodiments, a sensitivity adjustment control 174 may also be provided to allow the operator to select how quickly the mower 100 responds to the force F applied to the handle grip 124. This may be achieved by having a multi-position switch (not shown) mounted on the mower 100, such as in the sensor housing 105, with such switch having different sensitivity settings. Rather than using a physical switch carried on the mower 100, the sensitivity adjustment control 174 could be configured as a remote user interface connected to the mower via a wired or wireless connection (e.g., a smartphone application, etc.).

It will be readily apparent that the functionality of the controller 120 may be implemented in any manner known to one skilled in the art. For instance, the memory 123 may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While shown as both being incorporated into the controller 120, the memory 123 and the processor 122 could be contained in separate modules.

The processor 122 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 122 may include multiple components, such as any combination of one or more microprocessors, one or more controllers, one or more DSPs, one or more ASICs, and/or one or more FPGAs, as well as other discrete or integrated logic circuitry. The functions attributed to the controller 120 and/or processor 122 herein may be embodied as software, firmware, hardware, or any combination of these.

The force sensor 104 may provide an input signal to the controller 120 (e.g., representative of the force applied to handle grip 124 by the operator) as a plus or minus voltage signal ranging from zero voltage (when the handle grip is in the handle neutral position) to a higher voltage (when the handle grip is in the handle maximum forward position). The controller 120 may then drive the mower 100 in the forward direction in proportion to the magnitude of the voltage signal. In some embodiments, the force sensor may be preloaded such that, when the sensor is in the sensor neutral position xs0 (corresponding to the handle grip being in the handle neutral position), the force sensor outputs a voltage signal greater than zero. Such a preload may be useful to, for example, reduce backlash. In some embodiments, it may also be beneficial to tare or “zero” the force sensor periodically (e.g., before engagement of the handle grip 124) to negate any undesirable effects of variation in force sensor behavior and signal drift. In general, taring may effectively reset output voltage of the force sensor to zero when the handle grip is in its handle neutral position (e.g., before operation of the mower). Taring may be achieved with any of the embodiments described herein by, for example, electrically zeroing the output signal of the force sensor whenever the operator engages the bail 126 (moves the bail from the open position of FIG. 3 to the closed position (not shown but abutting the handle grip 124)).

As stated above, while voltage control of the propulsion motor 117 is contemplated, the controller may also provide torque control of the propulsion motor by varying the current supplied to the motor 117 (rather than varying voltage). Changing the voltage supplied to the motor 117 can quickly change the rotational speed of the drive wheels 108 and may lead to “jumpy” responses or allow the drive wheels 108 to slip as the mower 100 accelerates. Even with such torque control however, the controller 120 may limit how quickly motor voltage can ramp to assist with minimize wheel slippage. While such control uses both current and voltage commands, other controllers could employ either current or voltage control alone.

Various other modifications are also contemplated. For example, the handle grip 124 could be formed as the cross member 136 of the handle frame 132 as long as the cross member could move or deflect (e.g., pivot) relative to the handle tubes 134 by an amount sufficient to fully actuate the force sensor 104. Moreover, while shown as using a single force sensor 104, two force sensors could be provided. Such dual force sensors could be placed in parallel with one force sensor 104 being mounted near (or in) each handle tube 134 as an example. Alternatively, the dual force sensors 104 could be placed perpendicularly to each other with one force sensor extending along the handle and the other force sensor extending laterally side-to-side. In either configuration, the use of two force sensors 104 could detect a difference in the force applied by the operator to laterally spaced portions of handle grip 124. This detected lateral difference in the applied force could then be used by the controller 120 to control separate propulsion motors (one associated with each drive wheel) for effectively steering the mower 100. Alternatively, the signals from both of the two force sensors 104 could be averaged to account for operators who are more dominant with one hand.

FIGS. 9-14 illustrate a handle 202 in accordance with alternative embodiments of the present disclosure. Aspects described herein with respect to one embodiment (handle 102) may also be applicable to other embodiments (handle 202) unless indicated otherwise. Moreover, like components of the handles 102 and 202 may be identified with similar series reference numerals (e.g., the handle tubes are labeled 134 for handle 102 and 234 for handle 202).

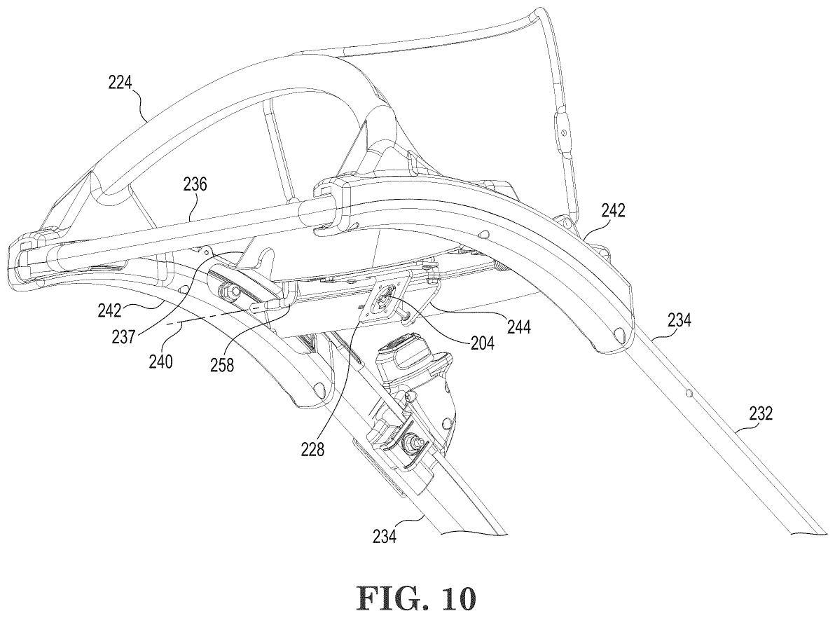

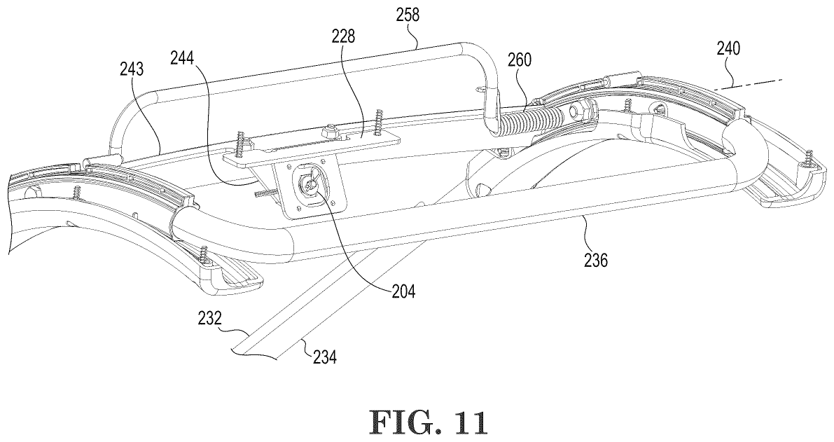

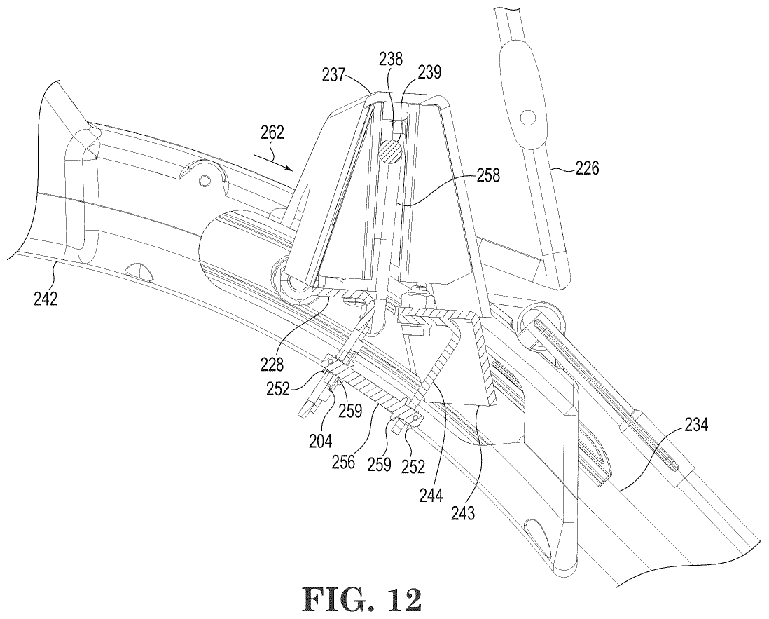

As shown in FIGS. 9-10, the handle 202, like the handle 102, may include a handle frame 232 having upper and lower portions, as well as two handle tubes 234 and a cross member 236 joining the upper ends of the two handle tubes. The handle 202 also includes a handle grip 224 having legs 242, and a bail 226 configured to operate in a manner similar to like components of the handle 102. The handle grip may further include a cross member 237 that again defines a channel 238 operable to constrain an arm 239 of a pivot rod 258 as shown in FIG. 12 (section taken along line 12-12 of FIG. 9). The pivot rod 258 may, like the rod 158, be pivotally attached to the two handle tubes 234 such that the pivot rod may pivot about a pivot axis 240 and be biased toward a neutral position by a biasing member 260 as shown in FIG. 11.

However, unlike the handle 102, the handle 202 may use a force sensor 204 that is located generally equidistant between the two handle tubes 234 as shown in FIGS. 10 and 11. To accommodate the force sensor in this configuration, the handle 202 may further include a cross bar 243 fixed to the handle tubes 234 as shown in FIGS. 11-12. The cross bar 243 has attached thereto a bracket 244. The cross member 237 of the handle grip 224 also includes a bracket 228.

The force sensor 204 may be mounted to the bracket 228 as shown in FIG. 12, and an actuation shaft 256 may extend through aligned apertures in the force sensor 204 and bracket 228 (and optional washer), and through an aperture formed in the bracket 244. Cotter pins 252 may be inserted into holes formed in the protruding ends of the shaft 256 such that the shaft is held in place. The shaft further includes a first shoulder 259 adjacent the force sensor, and a second shoulder 259 adjacent the bracket 244, with both shoulders being located between the brackets 244 and 228.

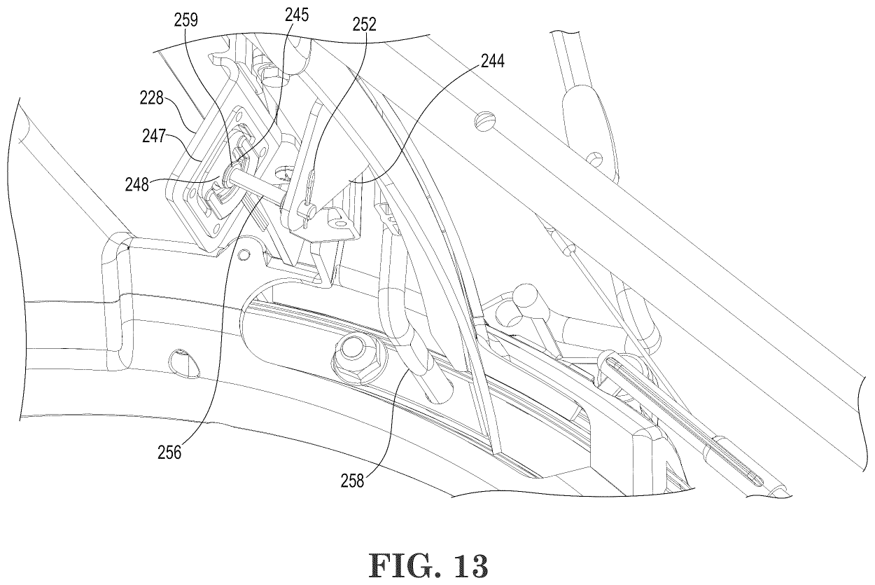

The force sensor 204 may have a construction the same or similar to the force sensor 104 already described herein. That is to say, it may have a base 247 (see FIG. 13), a hub 245 and a flexure 248 as already described herein above. The base may be fixed to the bracket 228, so that the actuation shaft 256 (via the shoulder 259) may act on the hub as further described below.

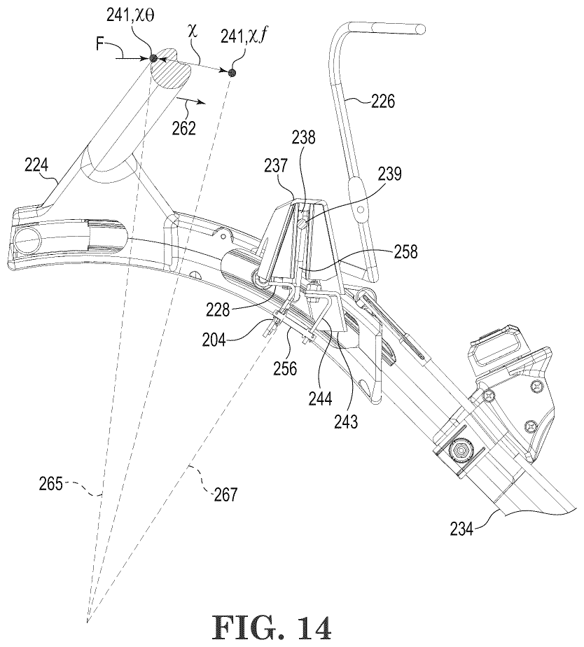

During operation, the operator may apply a forward force F to the handle grip 224 as shown in FIG. 14. As the force is applied, the handle grip 224 (including the cross member 237, bracket 228, and force sensor 204) moves downwardly along the curved handle tubes 234 in the direction 262 toward the housing 106. As the bracket 228 and force sensor 204 move, the first shoulder 259 (see FIG. 12) eventually contacts the hub of the force sensor while the second shoulder 259 contacts the bracket 244. Once the shoulders make such contact, the hub of the force sensor begins to deflect relative to the base, causing the strain-gaged flexure to generate a signal proportional to the force F applied by the operator in a manner already described herein above. As one can appreciate, like the handle 102, the handle 202 may be configured to accommodate propulsion in the reverse direction as well.

Like the handle 102, the handle 202 may provide a linear travel of the handle grip (maximum forward handle travel range x, depicted as a point 241 moving from a handle neutral position x0 to a handle maximum forward position xf in FIG. 14) that is greater than the maximum forward sensor travel range (see, e.g., FIG. 7). For example, the maximum forward sensor travel range may be 50% or less, 25% or less, 10% or less, or 5% or less than the maximum forward handle travel range. This relationship in travel ranges is at least partially due to the geometry of the offset arm 239 of the pivot rod 258 relative to the distance of the shaft 256 from the pivot axis 240. Once again, this geometry may result in a ratio of force Fs applied to the sensor to Force F applied to the handle grip of 1.5:1 or greater, e.g., 2:1 in some embodiments. Other factors, e.g., the handle grip 224 being located at a radial distance 265 from the center of the curved path along which the handle grip moves that is greater than a radial distance 267 at which the force sensor 204/actuation shaft 256 lie from the center of the curved path may also affect this relationship.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described and reference has been made to possible variations of the same. These and other variations, combinations, and modifications will be apparent to those skilled in the art, and it should be understood that the claims are not limited to the illustrative embodiments set forth herein.

1. A power equipment unit comprising:
a housing supporting a tool;
an electric motor configured to provide the housing with powered movement over a ground surface at a variable ground speed;
a handle extending rearwardly from the housing and configured to allow an operator to guide the housing during the powered movement over the ground surface, wherein the handle is movable over a maximum forward handle travel range spanning between: a handle neutral position; and a handle maximum forward position;
a force sensor responsive to a force applied to the handle, wherein at least a portion of the force sensor is configured to travel over a maximum forward sensor travel range spanning between: a sensor neutral position, corresponding to the handle neutral position; and a maximum forward sensor output position, corresponding to the handle maximum forward position; and
a controller configured to receive input from the force sensor to control the electric motor to increase the ground speed of the housing in a forward direction when increasing force is applied to the handle,
wherein the maximum forward sensor travel range is 50% or less of the maximum forward handle travel range.

2. The power equipment unit of claim 1, wherein the maximum forward sensor travel range is 25% or less of the maximum forward handle travel range.

3. The power equipment unit of claim 1, wherein the maximum forward handle travel range is 25 millimeters or less.

4. The power equipment unit of claim 1, wherein the maximum forward sensor travel range is three millimeters or less.

5. The power equipment unit of claim 1, wherein the force sensor is a load cell.

6. The power equipment unit of claim 1, further comprising a slope sensor configured to detect when the housing is traversing a hill, and wherein the controller receives input from the slope sensor to automatically vary velocity or torque output of the electric motor in response thereto.

7. The power equipment unit of claim 1, wherein the handle comprises a handle frame carrying a handle grip configured to move relative to the handle frame over the maximum forward handle travel range, wherein the force sensor acts between the handle frame and the handle grip.

8. The power equipment unit of claim 7, further comprising a spring configured to bias the handle grip to the handle neutral position.

9. The power equipment unit of claim 7, wherein the handle frame comprises two laterally-spaced handle tubes, and wherein the force sensor is positioned between the two handle tubes.

10. The power equipment unit of claim 9, wherein each handle tube comprises a curved segment such that the handle grip moves along a curved path over at least a portion of the maximum forward handle travel range.

11. The power equipment unit of claim 7, further comprising:
a pivot rod pivotally connected to the handle frame, wherein a captured portion of the pivot rod is engaged with the handle grip such that movement of the handle grip relative to the handle frame produces pivotal movement of the pivot rod; and
an actuation link connecting the pivot rod to the force sensor.

12. The power equipment unit of claim 1, further comprising ground-engaging members powered by the electric motor and operable to support the housing upon the ground surface.

13. The power equipment unit of claim 1, wherein the force sensor comprises: a stationary portion; and a movable portion configured to move or deflect relative to the stationary portion.

14. A power equipment unit comprising:
a housing supporting a tool;
an electric motor configured to provide the housing with powered movement over a ground surface at a variable ground speed;
a handle extending rearwardly from the housing and configured to allow an operator to guide the housing during the powered movement over the ground surface, wherein the handle comprises a handle frame and a handle grip coupled to the handle frame, the handle grip movable, relative to the handle frame, over a maximum forward handle travel range spanning between: a handle neutral position; and a handle maximum forward position;
a force sensor responsive to a force applied to the handle grip, wherein at least a portion of the force sensor is configured to travel over a maximum forward sensor travel range spanning between: a sensor neutral position, corresponding to the handle neutral position; and a maximum forward sensor output position, corresponding to the handle maximum forward position;
a bellcrank having a first arm connected to the handle grip and a second arm connected to the force sensor; and
a controller configured to receive input from the force sensor to increase speed or torque of the electric motor when increasing force is applied to the handle grip.

15. The power equipment unit of claim 14, wherein the bellcrank is configured to provide a force Fs to the force sensor that is greater than a force F applied to the handle grip.

16. The power equipment unit of claim 15, wherein a ratio of Fs:F is 1.5:1 or greater.

17. The power equipment unit of claim 14, wherein the handle frame comprises a curved segment such that the handle grip moves along a curved path over at least a portion of the maximum forward handle travel range.

18. The power equipment unit of claim 14, further comprising an actuation link connecting the second arm of the bellcrank to the force sensor.

19. The power equipment unit of claim 18, wherein the actuation link is connected to the second arm of the bellcrank and to the force sensor by pivoting connections.

20. A power equipment unit comprising:
a housing supporting a tool;
an electric motor configured to provide the housing with powered movement over a ground surface at a variable ground speed;
a handle extending from the housing and configured to allow an operator to guide the housing during the powered movement over the ground surface, wherein the handle is movable over a maximum handle travel range spanning between: a handle neutral position; and a handle maximum position;
a force sensor responsive to a force applied to the handle, wherein at least a portion of the force sensor is configured to travel over a maximum sensor travel range spanning between: a sensor neutral position, corresponding to the handle neutral position; and a maximum sensor output position, corresponding to the handle maximum position; and
a controller configured to receive input from the force sensor to control the electric motor to increase the ground speed of the housing when increasing force is applied to the handle,
wherein the maximum sensor travel range is 50% or less of the maximum handle travel range.

21. The power equipment unit of claim 20, wherein the controller is configured to increase the ground speed of the housing in a forward direction when the handle is moved toward the handle maximum position from the handle neutral position.

22. The power equipment unit of claim 20, wherein the controller is configured to increase the ground speed of the housing in a reverse direction when the handle is moved toward the handle maximum position from the handle neutral position.
